(19) United States
(12) Patent Application Publication
(10) Pub. No.: US 2025/0268782 A1
(43) Pub. Date: Aug. 28, 2025

(54) METHODS OF STIMULATION USING MULTIPLE VIBRATIONAL ASSEMBLIES

(71) Applicant: The Alfred E. Mann Foundation for Scientific Research, Valencia, CA (US)

(72) Inventors: Brian MECH, Buffao, MN (US); Neil TALBOT, La Crescenta, CA (US)

(21) Appl. No.: 19/067,722

(22) Filed: Feb. 28, 2025

Related U.S. Application Data
(60) Provisional application No. 63/559,078, filed on Feb. 28, 2024.

(51) Int. Cl. A61H 23/00

(52) U.S. Cl. CPC A61H 23/004; A61H 23/008; A61H 2201/164; A61H 2201/165; A61H 2201/5002; A61H 2201/5005; A61H 2201/5097; A61H 2205/106; A61H 2205/108

(57) ABSTRACT

The present disclosure relates to systems and methods for therapeutic nerve stimulation, particularly systems based on vibratory stimulation. Vibratory stimulation offers multiple advantages over other minimally or non-invasive neuromodulation techniques. In some aspects, the disclosure provides minimally invasive neuromodulation devices that can deliver stimulation when placed on the skin, as well as configurations that utilize percutaneous structures that extend into the body below the surface of the skin to transfer vibrational energy into the body.

### CROSS-REFERENCE TO RELATED APPLICATION

The present application claims the benefit of priority to U.S. Provisional Application No. 63/559,078, filed Feb. 28, 2024, the entire contents of which is incorporated by reference in its entirety.

### TECHNICAL FIELD

The present disclosure relates to systems and methods for therapeutic nerve stimulation, particularly systems based on vibratory stimulation.

### BACKGROUND

Non-invasive neuromodulation techniques, including electrical stimulation, have been demonstrated to be useful for a variety of conditions. For example, efforts have been made to treat pain and migraines using electrical stimulation. The effectiveness of non-invasive electrical stimulation is often constrained by the need to precisely target individual nerves for treatment, and due to working distance (depth) limitations, which limit treatment to accessible nerves close to the skin surface of the subject being treated. Moreover, at therapeutic levels, current devices can create sensations, skin irritation, and other side effects that are not pleasant. Transcranial stimulation such as magnetic (TMS) or Electroconvulsive Therapy (ECT) or direct current stimulation (DCS) have a larger working depth and stimulate larger areas in the brain, but they are typically administered through expensive pieces of capital equipment that must be accessed in a clinical environment, as opposed to being used at home. Accordingly, current devices, systems, and methods for minimal or non-invasive neuromodulation suffer from many drawbacks which limit widespread use of this technique as a therapeutic treatment. The present disclosure addresses these and other shortcomings in the art.

### SUMMARY OF SELECTED ASPECTS

The devices, systems, and methods for minimal or non-invasive neuromodulation described herein address various shortcomings in the art, e.g., by relying upon the use of mechanical (e.g., vibratory) stimulation as a modality. In some aspects, such systems and methods utilize multi-focal vibratory stimulation to target multiple tissues, anatomical areas, or other targets. The use of tandem stimulation, in some aspects, provides improved and/or syngeristic results as compared to systems and methods which direct treatment to a single target. Vibratory stimulation may be used to stimulate both the sympathetic and parasympathetic nervous systems. Furthermore, vibratory devices offer multiple benefits as compared to current electrical stimulation devices, including, e.g., such devices allow for a greater working depth compared to electrical stimulation, as well as a greater treatment area since vibrations are attenuated less quickly than an electrical field. The increased treatment area is further advantageous in that it requires less precise targeting by a user, as compared to electrical stimulation. Other advantages shall be described in further detail herein in the context of exemplary aspects or are otherwise apparent in view of the present disclosure.

In a first general aspect, the disclosure provides a multi-focal neuromodulation system, comprising: a plurality of vibratory stimulator assemblies, each at least partially contained in a housing and configured to generate vibration by mechanical oscillation and/or using a sound wave; and a controller, wherein the controller is configured to set or adjust one or more parameters of the vibratory stimulator assemblies; wherein the vibration generated by the vibratory stimulator assemblies is configured to therapeutically treat a subject by stimulating one or more nerves of the subject.

In some aspects, the one or more parameters comprise a cadence, frequency, amplitude, duration, duty cycle, pulse train length, and/or pulse train duty cycle, of the vibration generated by one or more of the vibratory stimulator assemblies. As used herein, the term “cadence” refers to the schedule or timing of stimulation generated by each vibratory stimulator assembly. Cadence defines how often and for how long stimulation events occur within a specified time period. For example, the cadence of a vibratory stimulator assembly may be configured to stimulate for 15 minutes every hour, representing an hourly cadence with a 25% cadence duty cycle (as stimulation occurs for 25% of the hour). Within the stimulation period, the vibratory stimulator may operate in a pulsatile manner. For instance, the stimulation may be delivered in 2-second on and 2-second off intervals, resulting in a pulse duty cycle of 50% with a pulse frequency of once every 4 seconds.

Cadence is distinct from the vibration frequency of the stimulator. Vibration frequency refers to the rate of oscillation of the vibration during the stimulation period (e.g., 10 Hz to 1.5 kHz or 20 kHz to 12 MHz). Cadence, on the other hand, describes the overarching schedule or timing of when stimulation occurs, independent of the vibration frequency. Accordingly, each vibratory stimulator assembly may have distinct parameters for cadence, vibration frequency, cadence duty cycle, and pulse duty cycle, all of which can be independently configured.

In some aspects, the cadence of each of the vibratory stimulator assemblies is selected from: a) continuous vibration, with or without a duty cycle; b) periodic vibration following a predetermined schedule; or c) no vibration. In some aspects, the vibration frequency and/or the cadence frequency may each have a duty cycle. The duty cycle may be independently selected for each of these parameters. In some aspects, the predetermined schedule comprises: a) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 seconds; b) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes; c) every 1, 2, 3, 4, 5, 6, 7, 8, 9, 10, 11, 12, 13, 14, 15, 16, 17, 18, 19, 20, 21, 22, 23, or 24 hours; or d) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 times per day; e) once, twice, or three times, every 1, 2, 3, 4, 5, 6, 7 days.

In some aspects, the controller is configured to organize the vibratory stimulator assemblies in two or more groups, wherein each group is set to have the same cadence.

In some aspects, the vibratory stimulator assemblies are organized into 2, 3, 4, 5, 5, 6, 7, 8, 9 or 10 groups.

In some aspects, a) each of the plurality of vibratory stimulator assemblies is positioned within a different housing; or b) one or more of the vibratory stimulator assemblies is positioned within the same housing.

In some aspects, each housing is configured to be worn, placed on, or implanted in, a human body.

In some aspects, the controller comprises software code executed on a mobile phone, a computer, or a dedicated hardware device.

In some aspects, the controller is configured to: a) determine which of the housings are required to therapeutically treat the subject; b) detect whether the subject is currently wearing or in contact with the required housings; and c) generate an alert if one or more of the required housings are not detected as being worn or in contact with the subject; optionally, wherein the alert is an audible, visual, or text-based alert.

In some aspects, the controller comprises software code executed on a mobile phone, and the controller is configured to wirelessly communicate with and control the one or more vibratory stimulator assemblies.

In some aspects, each housing comprises: a head-mounted system; an adhesive patch; a cuff; a watch; a wristband; an article of clothing, optionally a shirt, a vest, a scarf, a sock, a glove, pants, leggings, a hat, a sleeve, an undergarment, and/or a compression garment.

In some aspects, the controller is configured to set or adjust a frequency of one or more of the vibratory stimulator assemblies between 200 Hz and 1.5 kHz or between 20 kHz and 12 MHz.

In some aspects, the controller is configured to set or adjust a frequency of one or more of the vibratory stimulator assemblies to: a) a frequency of 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 Hz, or a frequency within a range defined by a pair of endpoints selected from 200, 250, 300, 350, 400, 450, 500, 550, 600, 650, 700, 750, 800, 850, 900, 950, 1000, 1050, 1100, 1150, 1200, 1250, 1300, 1350, 1400, 1450, and 1500 Hz; b) a frequency of 20, 40, 60, 80, 100, 150, 200, 250, 300, 350, 400, 450, 500, 550, 600, 650, 700, 750, 800, 850, 900, 950, or 1000 kHz, or a frequency within a range defined by a pair of endpoints selected from 20, 40, 60, 80, 100, 150, 200, 250, 300, 350, 400, 450, 500, 550, 600, 650, 700, 750, 800, 850, 900, 950, or 1000 kHz; c) a frequency of 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz, or a frequency within a range defined by a pair of endpoints selected from 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz; or d) a frequency within a range defined by a pair of endpoints selected from any of the frequencies listed in a)-c) of this passage.

In some aspects, the one or more nerves of the subject comprise a saphenous nerve, a tibial nerve (e.g., a posterior tibial nerve), a trigeminal nerve, or a vagus nerve.

In a second general aspect, the disclosure provides a method of treating a subject using multi-focal neuromodulation using any of the systems disclosed herein.

In some aspects, such methods comprise: a) providing a plurality of vibratory stimulator assemblies configured to be placed on or in proximity to a skin surface of the subject during operation, wherein each is at least partially contained in a housing and configured to generate vibration by mechanical oscillation and/or using a sound wave; b) providing a controller configured to set or adjust one or more parameters of the vibratory stimulator assemblies; c) stimulating one or more nerves of the subject using the controller, by initiating vibration of the vibratory stimulator assemblies; and d) reducing or eliminating one or more symptoms of a medical condition or disease, or improving the health, of the subject

In some aspects, the medical condition or disease is associated with urinary and/or fecal dysfunction, e.g., a urinary incontinence-related pathology, fecal incontinence-related pathology, urinary retention, underactive bladder, neurogenic bowel dysfunction, pelvic floor muscle dysfunction, or nerve damage to the pudendal, sacral, parasympathetic, or sympathetic nerves.

In some aspects, the medical condition or disease (e.g., underactive bladder, “UAB”) is treatable by stimulation (e.g., vibratory or electrical stimulation) using a device or method as described herein, wherein the stimulation is applied unilaterally and/or bilaterally. For example, unilateral or bilateral stimulation of the pudendal visceral nerve (Barrington Reflex #2), the parasympathetic nerve (Barrington reflex #7) and/or the sympathetic nerve (Barrington Reflex #3), may be used to alleviate UAB. In some aspects, stimulating even one of these nerves unilaterally (1 target), or groups of them unilaterally or bilaterally (up to 6 targets) can alleviate UAB and produce voiding of the bladder.

In some aspects, the medical condition or disease is an overactive bladder.

In some aspects, the medical condition or disease is migraine or cluster headache.

In some aspects, the medical condition or disease is allergic rhinitis, sinus blockage or sinus headache.

In some aspects, the medical condition or disease is one or more of the following: arthritis, lupus, celiac disease, Crohn's disease, ulcerative colitis, or multiple sclerosis.

In some aspects, the medical condition or disease is one or more of the following: asthma, Alzheimer's disease, Parkinson's disease, chronic obstructive pulmonary disease (“COPD”), inflammatory bowel disease, heart disease, or high blood pressure.

In some aspects, the one or more parameters set or adjusted during such methods comprises: a cadence, frequency, amplitude, duration, duty cycle, pulse train length, and/or pulse train duty cycle, of the vibration generated by one or more of the vibratory stimulator assemblies.

In some aspects, treatment comprises vibratory stimulation provided by one or more vibratory stimulator assemblies configured to implement a cadence comprising: a) continuous vibration, with or without a duty cycle; b) periodic vibration following a predetermined schedule; or c) no vibration; wherein one or more associated controllers are configured to set or adjust the cadence of each of the vibratory stimulator assemblies before, at the start of, and/or during treatment.

In some aspects, treatment comprises vibratory stimulation provided by one or more vibratory stimulator assemblies configured to provide vibratory stimulation according to a predetermined schedule. Optionally, the predetermined schedule comprises a) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 seconds; b) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes; c) every 1, 2, 3, 4, 5, 6, 7, 8, 9, 10, 11, 12, 13, 14, 15, 16, 17, 18, 19, 20, 21, 22, 23, or 24 hours; or d) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 times per day; e) once, twice, or three times, every 1, 2, 3, 4, 5, 6, 7 days.

In some aspects, the controller is configured to organize the vibratory stimulator assemblies into two or more groups, wherein each group is set to have the same cadence during the course of treatment using the methods disclosed herein.

In the methods of treatment contemplated herein, a multi-focal neuromodulation system may include any of the components described herein. For example, the housing containing a vibratory stimulator assembly may comprise, e.g., a harness configured to be worn by a user, or a case configured to be strapped to or placed on a skin surface of the user. While in many aspects the vibratory stimulators are intended to be non-invasive devices, it is contemplated that a vibratory stimulator may also be injected or implanted into a user without departing from the spirit of the present disclosure. One or more controllers may be used to control, configure, and/or operate the vibratory stimulators described herein. Each controller may comprise, e.g., a dedicated hardware unit, or software executed on a user device (e.g., a mobile phone or tablet computer). Moreover, each controller may comprise a general-purpose device (or software) that can be programmatically configured to treat multiple medical conditions or diseases, or a specific-purpose device (or software) with settings (e.g., cadence, frequency, amplitude, duration, and/or duty cycle of the vibration) programmed for the treatment of a specific medical condition or diseases. In some aspects, e.g., methods of treatment may comprise the use of neuromodulation systems, as described herein, wherein a user is allowed to select a desired outcome (e.g., a reduction in overactive bladder symptoms), and the system is configured to automatically select or modulate one or more settings of the treatment (e.g., any of the parameters described herein) to achieve the desired outcome, e.g., using a controller. In still further aspects, the neuromodulation systems described herein may be used to improve health or wellness in a subject unrelated to any specific medical condition or disease.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an exemplary embodiment of a vibration-based neuromodulation device in accordance with the present disclosure. In this example, a single controller (102) is used to control a plurality of vibratory stimulator assemblies (101).

FIG. 2 is a block diagram illustrating an exemplary embodiment of a vibration-based neuromodulation device in accordance with the present disclosure. In this example, a plurality of controllers (102) are used to control a plurality of vibratory stimulator assemblies (101). As illustrated by this example, one controller (102) may operate as a primary controller, and communicate with and control one or more secondary controllers (102).

FIG. 3 is a conceptual flow diagram of a process for treating a subject (e.g., to reduce one or more symptoms of an overactive bladder) using a multi-focal neuromodulation system according to an exemplary aspect of the disclosure.

FIG. 4 is a diagram showing the placement of two vibratory stimulator assemblies (101) on the leg of a subject (e.g., to apply stimulation to a saphenous nerve of the subject). In this case, one vibratory stimulator assembly (101) is in a housing (103) strapped to the subject's leg above the knee, and the second vibratory stimulator assembly (101) is in a housing (103) strapped to the subject's leg below the knee.

FIG. 5 is a diagram showing the placement of a vibratory stimulator assembly (101) on the leg of a subject (e.g., to apply stimulation to a saphenous nerve of the subject). In this case, the vibratory stimulator assembly (101) is in a housing (103) strapped to the leg in proximity to the distal end of the tibia.

FIG. 6 is a diagram showing the placement of a vibratory stimulator assembly (101) in proximity to the ankle of a subject. In this example, a larger vibratory stimulator assembly (101) is used to stimulate both the tibial and saphenous nerves of the subject.

FIG. 7 is a diagram showing the placement of two vibratory stimulator assemblies (101) on the leg of a subject (e.g., to apply stimulation to a saphenous nerve of the subject), and wireless connections between the vibratory stimulator assemblies (101) and a controller (102) and a paired device (104).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of exemplary embodiments according to the present disclosure will now be presented with reference to various systems and methods. These systems and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” or “controller” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), application-specific integrated circuits (ASICs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Non-invasive, minimally invasive, and invasive examples of neuromodulation have been developed over the last several decades in order to treat human illness. For example, prior research has studied stimulation of the vagus nerve, deep brain, occipital nerve, trigeminal nerve, tibial nerve, hypoglossal nerve, sacral nerve, phrenic nerve, sphenopalatine ganglion, and supraorbital nerve, as well as magnetic and direct current stimulation of the cortex and other brain structures. This research has led to the development of non-invasive devices for the treatment of a range of medical conditions and diseases, e.g., pain, migraines, inflammatory diseases such as irritable bowel and rheumatoid arthritis, movement disorders, tinnitus, depression, sleep-disordered breathing, post-traumatic stress disorder (PTSD), substance withdrawal, and others. Most non-invasive neuromodulation systems in use today rely upon electrical stimulation of a chosen target (e.g., one or more nerves or muscles). These devices have the advantage of being relatively inexpensive to produce and being relatively easy to use by a layperson. However, electrical stimulation has significant limitations, such as a short working distance (e.g., depth), requiring nerves to come close to the surface of the skin to be accessible, and it can be difficult to ensure that the intended target is actually being stimulated since there are anatomical differences between people and commercial devices often do not include a targeting system. Moreover, at therapeutic levels, these devices can create sensations, skin irritation, and other side effects that are unpleasant. Transcranial stimulation such as magnetic (TMS) or Electroconvulsive Therapy (ECT) or direct current stimulation (DCS) have a larger working depth and stimulate larger areas in the brain, but these techniques are typically administered through expensive pieces of specialized equipment that are only available in a clinical environment, rendering such methods unsuitable for home use and thus limiting their application. Ultrasonic stimulation has emerged as an alternative neuromodulation therapy, but this modality is also generally limited to a clinical environment and often requires sophisticated targeting.

In view of these and other shortcomings, there exists a need in the art for new devices, systems, and methods for neuromodulation. To that end, the present disclosure provides a solution that utilizes mechanical stimulation (e.g., vibratory stimulation). Prior to the present disclosure, relatively little research has been conducted regarding this modality. For example, penile vibratory stimulation has been used to treat erectile disfunction and other male sexual conditions, and there is some basic research showing that vibro-tactile stimulation can stimulate both the sympathetic and parasympathetic nervous systems. However, little attention has been directed to the use of vibratory stimulation in devices, systems, and methods of treatment as presently contemplated.

Vibratory stimulation offers multiple advantages over other minimally or non-invasive neuromodulation techniques. As used herein, minimally invasive neuromodulation devices may include percutaneous structures that extend into the body below the surface of the skin to transfer vibrational energy into the body, as well as small devices that can be injected into the body (or inserted by some other minimally invasive means including a small incision or a trans-vascular approach). A percutaneous device may share many of the same features of a non-invasive device. In contrast, an implanted device will typically include a vibration source as well as a power source, which could be a battery (primary cell or rechargeable), or a circuit to receive power from outside the body. In one embodiment a small injectable housing contains a stimulator assembly comprising a vibration source (e.g., a piezoelectric element or motor) and a power supply capable of receiving power from an external source, such that when the means for applying power externally is in place (e.g., an RF coil) the device is actuated and capable of delivering vibratory stimulation to surrounding tissue (e.g., nerves and/or muscles) until the means for external power is removed or deactivated (e.g., by dedicated controller configured to communicate with the power supply).

The following description primarily focuses on non-invasive devices and systems. However, it is expressly understood that minimally invasive and implantable devices, are also contemplated within the scope of the present disclosure. Accordingly, any discussion of vibratory neuromodulation systems provided herein should be understood as also describing embodiments wherein some or all of the components or the device or system are injected (or implanted) into a subject, or provided via a percutaneous device. For example, the vibratory stimulator assemblies described herein may be incorporated (in whole or in part) into a housing to be injected or implanted into a subject (e.g., in a small housing to be injected subdermally within proximity to the surface of the subject's skin).

As noted above, vibratory stimulation using the systems provided herein offers various advantages. Perhaps most notably, such devices allow for a greater working depth compared to electrical stimulation. Related to this point, such devices also allow for a greater treatment area since vibrations are attenuated less quickly than an electrical field. Consequently, vibratory devices require less precise targeting compared to electrical stimulation, rendering such devices easier for use by a layperson (e.g., allowing for widespread use outside of a clinical environment). The stimulation systems described herein are thus easy to use, relatively inexpensive compared to electrical, ultrasonic, and other modalities, and can be used in an at-home setting. Furthermore, vibratory devices may cause fewer side effects (e.g., skin irritation) as compared to the unpleasant side effects observed when other modalities such as electrical stimulation are applied at therapeutic levels. Vibratory stimulation also offers the potential for multi-nerve or multi-target stimulation when placed in a location where more than one nerve or receptor is available to be stimulated (e.g., the ear, face, head, arm, leg, or neck). When one or more targets are present for stimulation, stimulation parameters (e.g., cadence, amplitude, pulse width, and/or frequency of vibration) may be tuned to selectively stimulate one target more than another.

Accordingly, in a general sense the devices, systems, and methods described herein may be used to provide vibratory stimulation to one or more regions of the human body to treat a medical condition or disease (e.g., symptoms of an overactive bladder). In some aspects, vibratory stimulation may be combined with another form of stimulation (e.g., electrical, magnetic, etc.) in the same general region of the body or in a different region to augment the treatment of a given medical condition or disease, or to concurrently treat another medical condition or disease (e.g., one that is comorbid, and more amenable to a different treatment modality). Accordingly, the non-invasive neuromodulation techniques described herein may be used to treat various medical conditions and diseases, including without limitation pain, incontinence, inflammation, cardiac issues, hypertension and other hemodynamic disorders, movement disorders, tinnitus, and many others.

In some exemplary aspects, a neuromodulation system may comprise one or more housings (103), which each at least partially contain a vibratory stimulator assembly (101) configured to generate vibration by mechanical oscillation and/or using a sound wave. In some aspects, a housing (103) may contain, or partially contain, a plurality of vibratory stimulator assemblies (101). Each housing (103) may be adhered to the body (e.g., as a patch affixed to the skin using an adhesive or with hook and loop fasteners), wrapped around a portion of the body, or otherwise kept in proximity to a region of the body. The vibratory stimulator assembly (101) may comprise a member or element that can mechanically oscillate, or produce a sound wave, in order to generate a vibration with a constant or variable amplitude. In some aspects, the vibratory stimulator assembly (101) may be configured to generate vibration occurring primarily in one direction. However, in other aspects such devices may generate vibration in two or three dimensions (e.g., the member may move in one, two, or three dimensions, or an attachment to the member may be used to translate a vibration in one direction into one or more other directions). For example, a vibratory stimulator assembly (101) may include a ball at the end of piston that moves in and out, the ball indenting the skin of the subject and spreading vibrations spherically in the body. In some aspects, the housing (103) may fully contain the stimulator assembly; in others, at least a portion of the stimulator assembly may be located outside of the housing. For example, the vibratory stimulator assembly (101) may include an element configured to extend out of the housing (103) and to generate vibration by transmitting a sound wave towards the surface of the subject's skin.

In some aspects, the housing (103) may further contain, in whole or in part, additional components used by the vibratory stimulator assembly (101). For example, the housing may contain a means of activating the member or element that can mechanically oscillate or produce a sound wave (e.g., a motor, a piezoelectric element, a magnetic oscillator, a solenoid, or any other mechanical or electronic component for producing vibration known in the art). In some aspects, the housing (103) may contain a power supply for the activator or for the member or element to enable vibration, such as a battery, or a power cord plugged into a wall outlet or another source of power.

In some aspects, vibratory neuromodulation systems as described herein may include memory configured to store settings for one or more parameters (e.g., cadence, frequency, amplitude, duration, or duty cycle settings for vibration) to be applied during treatment. For example, the memory may store settings for the treatment of various medical conditions or diseases. In some aspects, a subject may be allowed to select and/or modify settings for one or more of the parameters, e.g., using a physical or electronic interface included as part of the neuromodulation device. For example, the housing (103) may include an LCD or LED screen configured to display one or more parameters (e.g., cadence, frequency, amplitude, duration, or duty cycle settings for vibration) and to allow a user to increase or decrease the level of any of these parameters (e.g., allowing a user to increase the frequency of vibration applied, or to change the cadence of one or more of the vibratory stimulator assemblies (101). In some aspects, the interface may allow a user to select a medical device or disease, or a desired outcome (e.g., relaxation, improved sleep quality) and the device may be configured to select predetermined or optimized parameters associated with the selection.

In some aspects, the vibratory stimulator assembly (101) may be controlled using a separate controller (102) (e.g., software executed on a dedicated controller, phone, tablet, watch, computer or other electronic device). In such aspects, the vibratory stimulator assembly (101) is considered part of a neuromodulation system. The controller (102) may be configured to provide an interface, similar to the interface contemplated for embodiments which include an integrated interface (e.g., as part of the housing (103)). For example, the controller (102) may include an LCD or LED screen configured to display one or more parameters (e.g., cadence, frequency, amplitude, duration, or duty cycle settings for vibration) and to allow a user to modify, increase, or decrease any of these parameters (e.g., allowing a user to increase the frequency of vibration applied, or to modify the cadence of one or more of the vibratory stimulator assemblies (101)). In some aspects, the interface of the controller (102) may allow a user to select a medical device or disease, or a desired outcome (e.g., a reduction in one or more symptoms associated with overactive bladder) and the device may be configured to select predetermined or optimized parameters associated with the selection. Optionally, the controller (102) may allow a third party to modify treatment parameters or to make selections as described above (e.g., the controller (102) may allow a doctor or other medical professional to log-in from a remote location and to adjust the settings of the multi-focal neuromodulation system or any component thereof). In some aspects, boundaries (e.g., minimum and maximum values) may be programmed for each parameter based on the limitations of the vibratory neuromodulation assembly used, or the system. In some aspects, the controller (102) may be programmed to include default or recommended values expected to be therapeutically effective for one or more medical conditions, diseases, or desired outcomes.

For example, the controller (102) (or memory incorporated into the neuromodulation system) may be programmed to suggest (or allow) therapeutically effective vibrational frequencies within the range of 200 Hz and 1.5 kHz, or 20 kHz and 12 MHz, and to suggest (or allow) a user or select a vibrational frequency for each vibratory stimulator assembly (101) within either of these ranges. The interface for the neuromodulation system (e.g., provided by a controller (102)) may allow a user to select from a menu of desired potential outcomes (e.g., pain relief, relaxation, cardiac improvement, inflammation, cognitive performance). When a selection is made, the device may be configured to apply a default protocol to provide a therapy for the selected medical condition, disease, or desired outcome, which may or may not permit manual adjustment by the user. However, if it does permit manual adjustment, the boundaries for each parameter may, e.g., be a function of the desired outcome.

In some aspects, the interface may allow a user to be able to select a desired blend of outcomes, for example 80% pain relief, and 20% reduction in a particular symptom associated with a medical condition or disease. This may result in an appropriately weighted multi-modal stimulation with two sets of parameters (Frp, Ampp, PWp, DCp) and (Frf, Ampf, PWf, DCf) where the two stimulation sets are delivered interleaved in the appropriate weighting, or one set for a period of time, and the second (third, fourth, fifth, etc.) set thereafter for the appropriate period of time. It may also be that a blending of the parameter sets is appropriate such that stimulation occurs at one set of parameters that depends only on the blend of desired outcomes. A blend may be, e.g., a linear blend. For the example described above in this passage, a linear blend may be: Fr=0.8 Frp+0.2 Frf, Amp=0.8 AMPp+0.2 Ampf, etc. However, this example is non-limiting and it is understood that other mathematical combinations (e.g., non-linear combinations) may be more appropriate.

In some aspects, a neuromodulation system may include one or more sensors to monitor and record physiological parameters of the subject being treated, e.g., heart rate, heart rate variability, blood pressure, blood oxygen levels, sweat, conductivity, inflammation (including inflammatory biomarkers such as TNF or one or more Interleukins), an electrocardiogram (ECG), an electromyogram (EMG), an electroencephalogram (EEG), autonomic balance, cardiac output, arterial blood pressure, and/or vascular resistance data. Such data may be detected and/or measured by one or more sensors incorporated into the neuromodulation system (e.g., as an additional component within the housing (103) of a vibratory stimulator assembly (101)). In other aspects, the sensor may be incorporated into a separate device, such as a smart watch worn by the subject which may include a pulse oximeter, heart rate detector, etc. In still further aspects, the neuromodulation system may include a plurality of sensors. For example, at least one sensor may be included in the housing (102) of the vibratory stimulator assembly (101) or in a separate housing (102) communicatively-lined with the vibratory stimulator assembly (101) or a controller (102), and/or at least one sensor may be incorporated into a separate device worn by or in proximity to the user (e.g., as part of a smart watch, or phone).

Data collected using the one or more sensors may be used to control one or more parameters of the vibratory stimulation (cadence, amplitude, frequency, duty cycle, etc.), or to trigger activation or deactivation of vibration. For example, each vibratory stimulator assembly (101) may include a controller (102) module configured to execute an algorithm that modulates, activates, or deactivates vibration based on the sensor data (e.g., determining that vibration is required, or has achieved its objective, or has triggered an abnormal or unintended response). This control functionality may alternatively be executed by software running on a separate controller (102), as described above. In some aspects, the neuromodulation system may be configured to record: a) one or more parameters of the vibratory stimulation (cadence, frequency, pulse width, amplitude, duty cycle, period, etc.); b) changes made to the therapy during a session or over time, either by a user, a third party, or an automatic control algorithm, and the basis for a such change(s); and/or c) signals sensed by the one or more sensors, and optionally conclusions reached based on sensor signals (for example blood pressure was reduced by 15 mmHg).

The collected data may be stored locally (e.g., in memory incorporated into a controller (102) of the neuromodulation system) or transmitted to a remote or cloud-based storage. In some aspects, the neuromodulation system may include an interface for displaying any or all of the information that is recorded in both real-time, and or after a therapy session, including metrics that may be calculated or imputed from the therapeutic session. In some aspects, the neuromodulation system may include a wired or wireless communications system capable of allowing communication with a computer or mobile device (e.g., via BlueTooth or Wi-Fi). In some aspects, the neuromodulation system may be configured to transfer and/or store data on the computer or mobile device, or to connect to the cloud via the computer or mobile device, e.g., to upload this data. The collected and/or uploaded data may be analyzed by another person, or by using machine learning or artificial intelligence. The system may also be configured to allow for remote adjustment and/or remote troubleshooting (e.g., via the cloud).

As noted above, the vibration-based methods described herein may be paired with other modalities. Accordingly, multi-focal neuromodulation systems according to the disclosure may optionally include one or more additional stimulus mode(s) which provided, e.g., visual stimulus, sound stimulus, ultrasonic stimulus, electrical stimulus, and/or magnetic stimulus.

It should be appreciated that each of the individual components described herein may be incorporated into the housing (102) of a vibratory stimulator assembly (101), or housed in one or more other devices that are communicatively-linked to the neuromodulation system, or housed in a separate controller (102) device capable of controlling one or more components of the neuromodulation system (e.g., via a wired or wireless connection). The communicatively-linked device(s) may include, e.g., a mobile phone, tablet, computer, dedicated controller, or other electronic device. Similarly, any of the functions described herein may be performed by software or hardware components incorporated into any of the aforementioned devices (e.g., the housing (103) of a vibratory stimulator assembly (101), a separate housing (103) communicatively-linked to the housing (103) of the vibratory stimulator assembly (101), or a separate controller (102) device).

It should also be appreciated that there are several potential targets on the body where multi-focal vibrational stimulation could be used to modulate an illness or condition, and that the physical design and means of attachment for the first device, or plurality of devices, in the system to the body may vary depending on the stimulation target. For example, if the target were a limb, finger, toe, etc., a vibratory stimulator assembly (101) may be included in a housing designed to wrap around the entirety to the body feature, and have the member or element providing vibration in proximity of the intended stimulation target. One simple way to do this would be to provide a cuff that would contain the housing (103) of the vibratory stimulator assembly (101) (or be the housing (103) of the vibratory stimulator assembly (101)) and an adjustable diameter to enable the cuff to go around the body feature and subsequently be tightened to ensure proximity to the skin (for example a hook and loop based cuff as typically used for a sphygmomanometer). For embodiments where the exact pressure of the vibratory element against the skin may be important, a mechanical limiter may be used. Alternatively, in some aspects, one or more pressure sensors that provide feedback to the user or a mechanical control system that is adjusting the tightness of the cuff may be used.

While a cuff-based embodiment may be useful in many aspects, such configurations are not the only means of maintaining contact between the housing (103) of the vibratory stimulator assembly (101), or any communicatively-linked devices (e.g., containing additional sensors), and the body of the subject. For example, in some aspects the vibratory stimulator assembly (101) housing (103) may be included within a patch or the housing itself may form the patch, as another viable means for attaching the vibratory stimulator assembly (101) to the body. This patch may be attached using an adhesive, including an adhesive that can be activated and deactivated by some means to attach and release the patch from the body. Other methods of attachment may take advantage of anatomical features that provide easy means of attachment. For example, if the nose or the sub-orbital or supra-orbital region, or the temporal region or the side of the head (or all of these) were a desired stimulation target, the vibratory stimulator assembly (101) may be kept in proximity to the target(s) using a glasses-like structure, a goggles-like structure, or a halo-like structure such as that used in virtual or augmented reality. Where visual stimulation and or sound presentation is desired concurrent with vibrational stimulation, this may be a preferred structure. For example, a vibratory stimulator assembly (101) may be incorporated into a hat or halo-like embodiment intended to be worn on the head, optionally with augmented or virtual reality functionality and/or speakers, to provide audio and/or visual stimulation in addition to vibratory neuromodulation.

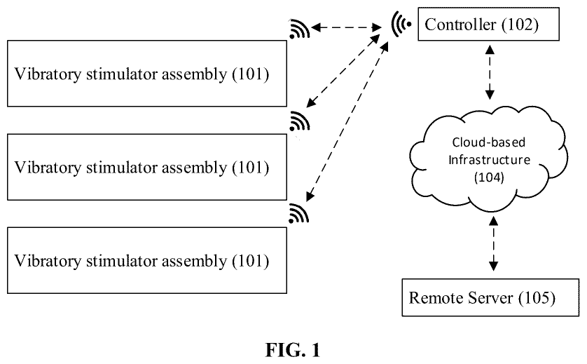

FIG. 1 is a block diagram illustrating an exemplary embodiment of a vibration-based neuromodulation device in accordance with the present disclosure. In this example, a single controller (102) is used to control a plurality of vibratory stimulator assemblies (101). Each of the vibratory stimulator assemblies (101) may be configured to apply stimulation to a different nerve, tissue, or anatomical region of the subject. For example, each of the vibratory stimulator assemblies (101) may be incorporated into a housing designed to be used as a head-mounted system, or in an adhesive patch or a cuff format, as described above. In other aspects, the vibratory stimulator assemblies (101) may be integrated into a watch or wristband, a piece of clothing such as a shirt, vest, scarf, sock, glove, pants, leggings, hat, sleeve, undergarment, and/or a compression garment. In some aspects, a vibratory stimulator assembly (101) may be incorporated into a garment that drapes around the neck with elements that rest on the chest, and or back, optionally including one or more straps to allow tightening so that the garment can be snuggly tightened against the skin (or clothing) to enable good contact of the vibratory stimulator assembly (101) with a skin surface of the subject being treated.

The controller (102) may be configured to set different parameters (cadence, frequency, amplitude, etc.) for each vibratory stimulator assembly (101). For example, the controller (102) may organize the vibratory stimulator assemblies (101) in different groups based upon their anatomical location, and to set a different cadence parameter for each vibratory stimulator assembly (101) or to different groups of vibratory stimulator assembly (101). As explained above, cadence refers to how often each assembly is stimulating. Any individual vibratory stimulator assembly (101), group of vibratory stimulator assemblies (101), or all of the vibratory stimulator assemblies (101), may be set to have a cadence that is continuous (with or without a duty cycle), or set to follow a predetermined schedule (e.g., every minute, or every 5 minute, or every 10 minutes, every 30 minutes, every hour, every two hours, every four hours, 3 times daily, twice daily, once a day, once every other day, once every 3 to 4 days, and once every week). In some aspects, the cadence may range anywhere between applying stimulation every second and once per week. Cadences could also be less frequent, spanning the range between once per week and once per year. Note that the cadence associated with any particular vibratory stimulator assembly (101), groups of vibratory stimulator assemblies (101), or all of vibratory stimulator assemblies (101) may be different, and may change over time. For example, a vibratory stimulator assembly (101) intended to stimulate the saphenous nerve may have a cadence of 4 times daily every day for 4 weeks, and then once weekly thereafter, while another vibratory stimulator assembly (101) intended to stimulate the tibial nerve may have a cadence of twice daily for 12 weeks, and then once every three months thereafter. In some aspects, the systems and methods described herein may use two or more vibratory stimulator assemblies and a controller configured to cause these vibratory stimulator assemblies to deliver stimulation according to an interleaved cadence whereby only one vibratory stimulator assembly is active at any given time. For example, in a system with two vibratory stimulator assemblies operating under an interleaved cadence, when vibratory stimulator assembly 1 is vibrating, vibratory stimulator assembly 2 is not, and vice versa. This would require a cadence duty cycle of 50% or less in this particular example.

Similarly, any of the other parameters associated with each vibratory stimulator assembly (101) (e.g., frequency, amplitude, duration, and duty cycle, pulse train length, pulse train duty cycle) may be individually programmable for each vibratory stimulator assembly (101). Thus, each vibratory stimulator assembly (101) may implement different parameters and/or those parameters could change over time. For example, each vibratory stimulator assembly (101) (or any groupings thereof) may be configured to apply vibratory stimulation at a different frequency, e.g., a) a frequency of 10, 20, 30, 40, 50, 60, 70, 80, 90, 100, 110, 120, 130, 140, 150, 160, 170, 180, 190, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 Hz, or a frequency within a range defined by a pair of endpoints selected from 200, 250, 300, 350, 400, 450, 500, 550, 600, 650, 700, 750, 800, 850, 900, 950, 1000, 1050, 1100, 1150, 1200, 1250, 1300, 1350, 1400, 1450, and 1500 Hz; b) a frequency of 20, 40, 60, 80, 100, 150, 200, 250, 300, 350, 400, 450, 500, 550, 600, 650, 700, 750, 800, 850, 900, 950, or 1000 kHz, or a frequency within a range defined by a pair of endpoints selected from 20, 40, 60, 80, 100, 150, 200, 250, 300, 350, 400, 450, 500, 550, 600, 650, 700, 750, 800, 850, 900, 950, or 1000 kHz; c) a frequency of 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz, or a frequency within a range defined by a pair of endpoints selected from 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz; or d) a frequency within a range defined by a pair of endpoints selected from any of the frequencies listed in a)-c).

In some aspects, the controller (102) may be configured to organize a plurality of vibratory stimulator assemblies (101) (e.g., each at least partially enclosed by a different housing) into different groups, allowing for the control of any of the stimulation parameters described herein on a group level. For example, each group of vibratory stimulator assemblies (101) may be set to have the same cadence, frequency, duty cycle, etc. In some aspects, stimulation parameters for any individual vibrational stimulator assembly (101), or group of vibratory stimulatory assemblies (101) may, e.g., be a) manually selected (e.g., by a user, a physician or other medical professional, or other third party), b) based on a predetermined schedule, or c) selected in response to one or more biometric parameters of the subject. In the case of the latter option, some embodiments may incorporate or be capable of communicating via a wired or wireless connection with one or more sensors configured to obtain a signal indicative of a biometric parameters of the subject. In some aspects, the controller (102) may communicate with a separate device (e.g., a smartwatch, phone, or other electronic device) that incorporates or is capable of communicating via a wired or wireless connection with one or more sensors. For example, the controller (102) may receive a signal indicative of one or more biometric parameters of the subject being treated (e.g., heart rate, blood pressure, SpO₂ level, respiratory cycle data, positional information for the subject or any individual anatomical part or region of a subject's body, etc.) and adjust one or more parameters of stimulation (at the individual vibrational stimulator assembly (101) or group level) based on the one or more parameters. In some aspects, the controller (102) may receive a precalculated or predetermined biometric parameter from a separate electronic device. For example, a sensor may communicate with user's smartwatch or phone, or any other electronic device, which in turn calculates or determines one or more biometric parameters based on the data provided by the sensor, and provides the result to the controller (102).

In addition to configuring treatment parameters, the controller (102) may provide additional functionality intended to encourage compliance or to otherwise improve the user's experience. For example, the controller (102) may provide reminders/alerts, a diary that the user can complete, forms or surveys for other user input, a user interface that allows the user and/or a health care professional, and/or another person to program parameters (cadence, and other vibratory stimulator assembly (101) stimulation parameters) either directly through the controller (e.g., configured as an application executed on a user's device) or remotely via a cloud connection. This ability to program may be secured through encryption. The controller (102) may also include an interface that provides game-like features and/or a “personality” to engage the user, challenge him or her, and generally increase therapy compliance. The controller (102) may also provide reporting to the subject being treated, and/or other entities (e.g., healthcare professionals), regarding metrics such as battery life and/or health, amount of time that any vibratory stimulator assemblies (101) have been worn or used, a summary of self-reported device efficacy, etc.

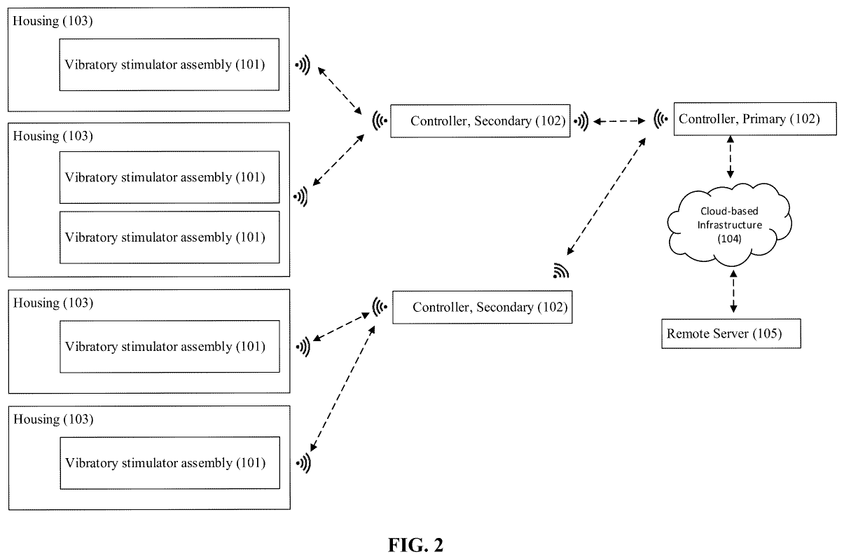

FIG. 2 is a block diagram illustrating an exemplary embodiment of a vibration-based neuromodulation device in accordance with the present disclosure. In this example, a plurality of controllers (102) are used to control a plurality of vibratory stimulator assemblies (101). As illustrated by this example, one controller (102) may operate as a primary controller, and communicate with and controller one or more secondary controllers (102). As explained above, systems according to the disclosure may include one controller (102) or a plurality of controllers (102) and the functions of the system may be allocated among such devices in any manner desirable for a given implementation. For example, a user's mobile device may include an executable software application that functions as the primary or master controller (102) of the system, and each vibratory stimulator assembly (101) may include a secondary controller (102) locally integrated into the housing of such devices. This configuration may be advantageous in that the secondary controllers (102).

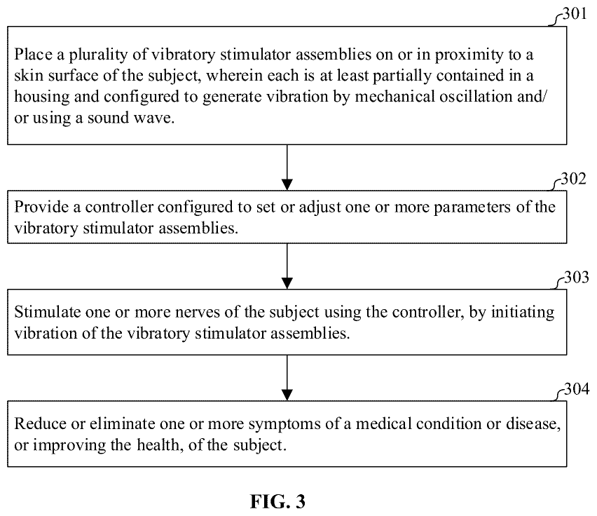

FIG. 3 is a conceptual flow diagram of a process for treating a subject (e.g., to reduce one or more symptoms of an overactive bladder) using a multi-focal neuromodulation system according to an exemplary aspect of the disclosure. As illustrated by this example, a method of treatment using the systems described herein may comprise, e.g., providing a plurality of vibratory stimulator assemblies (101) configured to be placed on or in proximity to a skin surface of the subject during operation, wherein each is at least partially contained in a housing (103) and configured to generate vibration by mechanical oscillation and/or using a sound wave (step 301); providing a controller (102) configured to set or adjust one or more parameters of the vibratory stimulator assemblies (101) (step 302); stimulating one or more nerves of the subject using the controller (102), by initiating vibration of the vibratory stimulator assemblies (101) (step 303); and reducing or eliminating one or more symptoms of a medical condition or disease, or improving the health, of the subject (step 304). In some aspects, the medical condition or disease is a urinary incontinence-related pathology (e.g., an overactive bladder). Treatment may comprise stimulation, e.g., of a saphenous nerve and/or a tibial nerve of the subject.

Methods of treatment according to the disclosure may incorporate any aspects of the systems described herein. For example, in some aspects, treatment may further comprise setting or adjusting one or more parameters of the vibratory stimulator assemblies (101) based on sensor data collected from one or more sensors communicatively-linked with the controller (102). In some aspects, treatment may further comprise adjusting one or more parameters of treatment (e.g., the cadence of one or more of the vibratory stimulator assemblies (101)) based on user input, sensor data, or a profile stored in memory of the system). For example, the controller (102) may be configured to store and execute different treatment profiles for different medical conditions or diseases, whereby one or more treatment parameters are initially applied and then adjusted during treatment (e.g., titrated upwards or downwards, or otherwise modified).

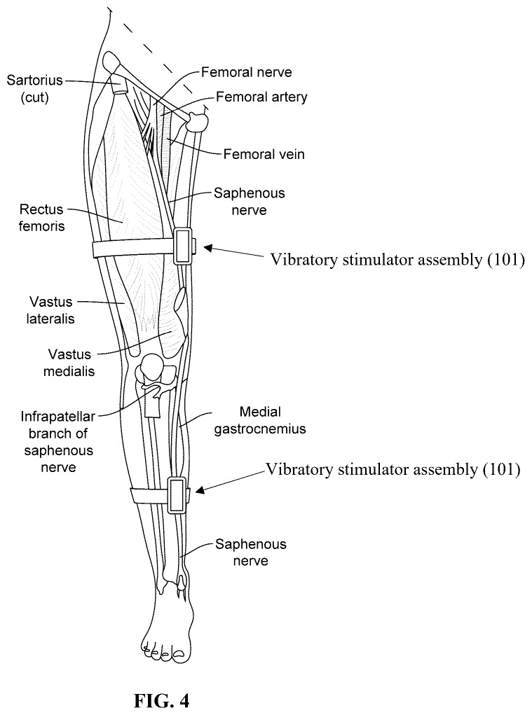

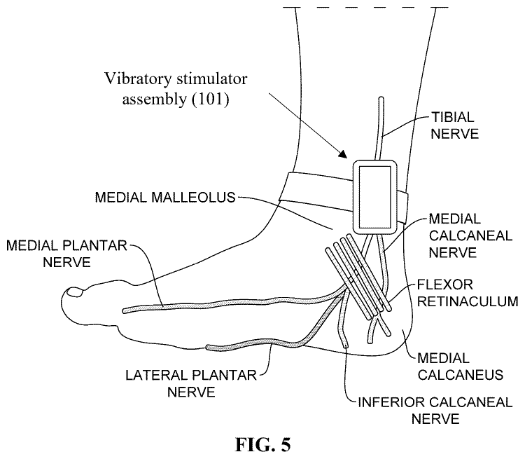

FIG. 4 is a diagram showing the placement of two vibratory stimulator assemblies (101) on the leg of a subject (e.g., to apply stimulation to a saphenous nerve of the subject). In this case, one vibratory stimulator assembly (101) is in a housing (103) strapped to the subject's leg above the knee, and the second vibratory stimulator assembly (101) is in a housing (103) strapped to the subject's leg below the knee. FIG. 5 is a similar diagram showing the placement of a vibratory stimulator assembly (101) on the leg of a subject (e.g., to apply stimulation to a saphenous nerve of the subject). In this case, the vibratory stimulator assembly (101) is in a housing (103) strapped to the leg in proximity to the distal end of the tibia.

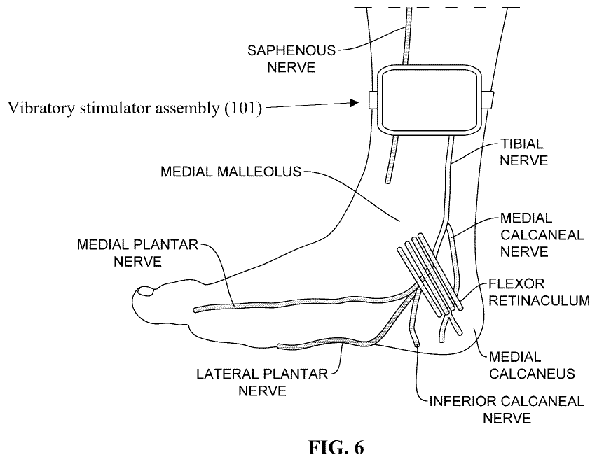

The placement of vibratory stimulator assemblies (101) in FIGS. 4-5 may be particularly useful for the treatment of urinary incontinence-related pathologies such as overactive bladder. The nerve targets of interest in this case are the saphenous and tibial nerves. These nerves could be stimulated simultaneously and bilaterally, continuously, or with different alternating or interleaved cadences as described above. This can be achieved using four vibratory stimulator assemblies (101), or six if both the proximal and distal locations are stimulated where the saphenous nerve gets close to the skin. FIG. 4 shows two stimulator assemblies positioned on the proximal and distal saphenous stimulation locations, respectively, of the right leg. FIG. 5 shows one stimulator assembly on the tibial nerve of the right ankle. In an alternative aspect (not shown), one could utilize three vibratory stimulator assemblies (101) on the left leg, mirroring the configuration shown in FIGS. 4-5. In theory, all six locations may be stimulated simultaneously or with different alternating or interleaved cadences. However, in order to reduce the number of vibratory stimulator assemblies (101) while maintaining therapeutic efficacy, it may be possible to only stimulate both nerves unilaterally or contralaterally. Alternatively, stimulating one or the other of the saphenous or tibial nerves bilaterally in a continuous or interleaved cadence may maintain the most therapeutic efficacy with only two stimulator assemblies. Lastly, a larger stimulator assembly (as shown in FIG. 6) may be used to stimulate both the superior part of the tibial nerve stimulation location and the inferior part of the distal saphenous stimulation location simultaneously.

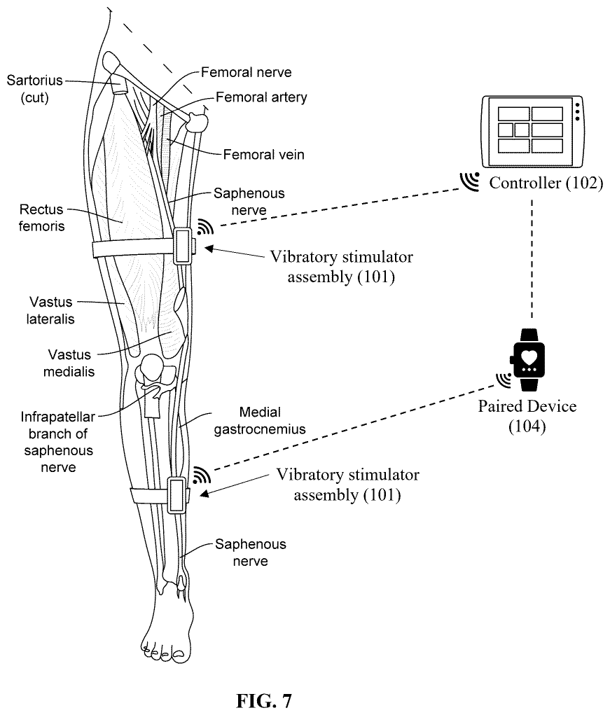

FIG. 7 is a diagram similar to FIG. 4, but which shows the placement of two vibratory stimulator assemblies (101) on the leg of a subject, and wireless connections between these vibratory stimulator assemblies (101) and a controller (102) and a paired device (104). As explained above, systems according to the present disclosure may utilize data from one or more sensors capable of detecting a signal indicative of a biometric parameter of the subject. Sensor data may be collected directly (e.g., a sensor may be integrated into the house of a vibrational stimulator assembly (101) or configured for wireless communication with a controller (102). In other aspects, the sensor(s) may be integrated into a separate device, such as a user's smartwatch or phone. This figure illustrates an embodiment wherein one vibrational stimulator assembly (101) is capable of wirelessly communicating with a paired device (104) (shown here as a smartwatch), while a second vibrational stimulator assembly (101) is capable of wirelessly communicating directly with the controller (102). It should be understood that any permutation of these connections is possible (e.g., both vibrational stimulator assemblies (101) may be configured to allow communication with both the controller (102) and one or more paired devices (104). Similarly, sensor data may be collected by any or all of the foregoing devices. Sensor data may be used to determine or calculate one or more biometric parameters (e.g., heart rate, heart rate variability, blood pressure, blood oxygen levels, sweat, conductivity, inflammation, respiratory cycle), either by the paired device (104), by the controller (102) or in some aspects by another device (e.g., a remote server). The biometric parameter(s) may be used, e.g., by the controller (102) as a factor for selecting or determining one or more stimulation parameters. For example, the controller (102) may be configured to increase, decrease, stop, temporarily pause, or start stimulation of one or more vibrational stimulator assemblies (101), or any group(s) thereof, in response to any biometric parameter or combination thereof described herein. Any of these actions may be triggered, e.g., based on a biometric parameter reaching, exceeding, or falling below a predetermined threshold or rate of change over time. In some aspects, the controller (102) may further be configured to log biometric parameter levels and/or to transmit sensor data or biometric parameter level data to a remote server (e.g., to allow a medical professional to review this data).

As illustrated by FIG. 4-7, the vibratory stimulator assemblies (101) described herein may be positioned on the skin surface of a subject in order to provide non-invasive neuromodulation of nerves known to be associated with medical diseases or conditions. In this example, the saphenous and tibial nerves are exemplified as therapeutic targets. However, it should be appreciated that any other nerves that are positioned near the skin surface in at least one location of the human body may also be targeted. For example, in some aspects, stimulation may be applied to the trigeminal nerve (e.g., via one or more vibratory stimulatory assemblies placed on or in proximity to the skin surface of the head of a user) in order to provide headache relief or other therapeutic benefits. In some aspects, one or more vibratory stimulatory assemblies may be placed in proximity to the lateral side(s) of a user's head (e.g., via a device affixed to the skin or held in place by a strap). In some aspects, one or more vibratory stimulatory assemblies may be placed on a skin surface in proximity to the vagus nerve at the cervical location and/or the auricular location to treat inflammatory diseases such as rheumatoid arthritis and potentially depression and epilepsy.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (and equivalent open-ended transitional phrases thereof like including, containing and having) encompasses all the expressly recited elements, limitations, steps and/or features alone or in combination with unrecited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amended for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Lastly, the terminology used herein is for the purpose of describing particular embodiments only, and is not intended to limit the scope of the present invention, which is defined solely by the claims. Accordingly, the present invention is not limited to that precisely as shown and described.

We claim:

1. A multi-focal neuromodulation system, comprising:
a plurality of vibratory stimulator assemblies, each at least partially contained in a housing configured to be worn, placed on, or implanted in, a human body, and configured to generate vibration by mechanical oscillation and/or using a sound wave; and
a controller, wherein the controller is configured to set or adjust one or more parameters of the vibratory stimulator assemblies, and to organize the vibratory stimulator assemblies in two or more groups, wherein each group is set to have the same cadence;
wherein the vibration generated by the vibratory stimulator assemblies is configured to therapeutically treat a subject by stimulating one or more nerves of the subject.

2. The system of claim 1, wherein the one or more parameters comprise a cadence, frequency, amplitude, duration, duty cycle, pulse train length, and/or pulse train duty cycle, of the vibration generated by one or more of the vibratory stimulator assemblies.

3. The system of claim 1, wherein the cadence of each of the vibratory stimulator assemblies is selected from:
a) continuous vibration, with or without a duty cycle;
b) periodic vibration according to a predetermined schedule; or
c) no vibration.

4. The system of claim 3, wherein the predetermined schedule comprises:
a) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 seconds;
b) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes;
c) every 1, 2, 3, 4, 5, 6, 7, 8, 9, 10, 11, 12, 13, 14, 15, 16, 17, 18, 19, 20, 21, 22, 23, or 24 hours; or
d) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 times per day;
e) once, twice, or three times, every 1, 2, 3, 4, 5, 6, 7 days.

5. The system of claim 2, wherein the controller is configured to adjust the cadence of the vibratory stimulator assemblies in at least one of the two or more groups over a period of time, wherein the adjustment and/or period of time is a) manually selected, b) based on a predetermined schedule, or c) in response to one or more biometric parameters of the subject; optionally, the controller may be further configured to select a different cadence for one or more of the two or more groups.

6. The system of claim 5, wherein the vibratory stimulator assemblies are organized into 2, 3, 4, 5, 6, 7, 8, 9 or 10 groups.

7. The system of claim 1, wherein each group of vibratory stimulator assemblies is configured to apply stimulation to a different anatomical location of the subject, and wherein each anatomical target is independently selected from a head, chest, abdomen, arm, leg, organ, or tissue of the subject.

8. The system of claim 1, wherein each housing is configured to be worn or placed on a human body.

9. The system of claim 1, wherein the controller comprises software code executed on a mobile phone, a computer, or a dedicated hardware device.

10. The system of claim 1, wherein the controller is configured to:
a) determine which of the housings are required to therapeutically treat the subject;
b) detect whether the subject is currently wearing or in contact with the required housings; and
c) generate an alert if one or more of the required housings are not detected as being worn or in contact with the subject;
optionally, wherein the alert is an audible, visual, or text-based alert.

11. The system of claim 1, wherein the controller comprises software code executed on a mobile phone, and the controller is configured to wirelessly communicate with and control the one or more vibratory stimulator assemblies.

12. The system of claim 1, wherein each housing comprises: a head-mounted system; an adhesive patch; a cuff; a watch; a wristband; an article of clothing, optionally a shirt, a vest, a scarf, a sock, a glove, pants, leggings, a hat, a sleeve, an undergarment, and/or a compression garment.

13. The system of claim 2, wherein the controller is configured to set or adjust a frequency of one or more of the vibratory stimulator assemblies between 10 Hz and 1.5 kHz or between 20 kHz and 12 MHz.

14. The system of claim 13, wherein the controller is configured to set or adjust a frequency of one or more of the vibratory stimulator assemblies to:
a) a frequency of 10, 15, 20, 30, 40, 50, 60, 70, 80, 90, 100, 120, 140, 160, 180, 200, 225, 250, 275, 300, 350, 400, 450, 500, 550, 600, 650, 700, 750, 800, 850, 900, 950, 1000, 1050, 1100, 1150, 1200, 1250, 1300, 1350, 1400, 1450, or 1500 Hz, or a frequency within a range defined by a pair of endpoints selected from 10, 15, 20, 30, 40, 50, 60, 70, 80, 90, 100, 120, 140, 160, 180, 200, 225, 250, 275, 300, 350, 400, 450, 500, 550, 600, 650, 700, 750, 800, 850, 900, 950, 1000, 1050, 1100, 1150, 1200, 1250, 1300, 1350, 1400, 1450, and 1500 Hz;
b) a frequency of 20, 30, 40, 50, 60, 70, 80, 90, 100, 125, 150, 175, 200, 225, 250, 275, 300, 350, 400, 450, 500, 550, 600, 650, 700, 750, 800, 850, 900, 950, or 1000 kHz, or a frequency within a range defined by a pair of endpoints selected from 20, 30, 40, 50, 60, 70, 80, 90, 100, 125, 150, 175, 200, 225, 250, 275, 300, 350, 400, 450, 500, 550, 600, 650, 700, 750, 800, 850, 900, 950, or 1000 kHz;
c) a frequency of 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz, or a frequency within a range defined by a pair of endpoints selected from 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5 or 14 MHz; or
d) a frequency within a range defined by a pair of endpoints selected from any of the frequencies listed in a)-c).

15. The system of claim 1, wherein the one or more nerves of the subject comprise a saphenous nerve, or a tibial nerve.

16. A method of treating a subject using multi-focal neuromodulation, comprising:
a) providing a plurality of vibratory stimulator assemblies configured to be placed on or in proximity to a skin surface of the subject during operation, wherein each is at least partially contained in a housing configured to be worn, placed on, or implanted in, a human body, and configured to generate vibration by mechanical oscillation and/or using a sound wave;
b) providing a controller configured to set or adjust one or more parameters of the vibratory stimulator assemblies, and to organize the vibratory stimulator assemblies in two or more groups, wherein each group is set to have the same cadence;
c) stimulating one or more nerves of the subject using the controller, by initiating vibration of the vibratory stimulator assemblies, optionally wherein the one or more nerves is a saphenous nerve or a tibial nerve of the subject; and
d) reducing or eliminating one or more symptoms of a medical condition or disease, or improving the health, of the subject.

17. The method of claim 16, wherein the medical condition or disease
a) is associated with urinary and/or fecal dysfunction;
b) comprises a urinary incontinence-related pathology; a fecal incontinence-related pathology; urinary retention; an underactive bladder; a neurogenic bowel dysfunction; a pelvic floor muscle dysfunction; or nerve damage to the pudendal, sacral, parasympathetic or sympathetic nerves;
c) comprises a migraine or cluster headache;
d) comprises allergic rhinitis, a sinus blockage, or a sinus headache;
e) comprises one or more of: arthritis, lupus, celiac disease, Crohn's disease, ulcerative colitis, or multiple sclerosis;
f) comprises one or more of: asthma, Alzheimer's disease, Parkinson's disease, chronic obstructive pulmonary disease, inflammatory bowel disease, heart disease, or high blood pressure; or
g) is an overactive bladder.

18. The method of claim 16, wherein the one or more parameters comprise a cadence, frequency, amplitude, duration, duty cycle, pulse train length, and/or pulse train duty cycle, of the vibration generated by one or more of the vibratory stimulator assemblies.

19. The method of claim 16, wherein the controller is configured to set or adjust a cadence of stimulation generated by one or more of the vibratory stimulator assemblies, and wherein the cadence of each of the vibratory stimulator assemblies is selected from:
a) continuous vibration, with or without a duty cycle;
b) periodic vibration following a predetermined schedule; or
c) no vibration.

20. The method of claim 19, wherein the predetermined schedule comprises:
a) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 seconds;
b) every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes;
c) every 1, 2, 3, 4, 5, 6, 7, 8, 9, 10, 11, 12, 13, 14, 15, 16, 17, 18, 19, 20, 21, 22, 23, or 24 hours; or
d) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 times per day;
e) once, twice, or three times, every 1, 2, 3, 4, 5, 6, 7 days.

21. The method of claim 16, wherein the controller is configured to adjust the cadence of the vibratory stimulator assemblies in at least one of the two or more groups over a period of time, wherein the adjustment and/or period of time is a) manually selected, b) based on a predetermined schedule, or c) in response to one or more biometric parameters of the subject.

22. The method of claim 16, wherein each housing is configured to be worn or placed on the human body.

23. The method of claim 16, wherein each group of vibratory stimulator assemblies is configured to apply stimulation to a different anatomical location of the subject, and wherein each anatomical target is independently selected from a head, chest, abdomen, arm, leg, organ, or tissue of the subject.
